(19) United States
(12) Patent Application Publication
(10) Pub. No.: US 2013/0076609 A1
(43) Pub. Date: Mar. 28, 2013

(54) LIQUID CRYSTAL DISPLAY DEVICE

(71) Applicant: Ken Inada, Osaka (JP)

(72) Inventor: Ken Inada, Osaka (JP)

(73) Assignee: SHARP KABUSHIKI KAISHA, Osaka (JP)

(21) Appl. No.: 13/702,140

(22) PCT Filed: Jun. 24, 2011
(86) PCT No.: PCT/JP2011/064593

§ 371 Date: Dec. 5, 2012

(30) Foreign Application Priority Data
Jul. 1, 2010 (JP) 2010-151372

(51) Int. Cl. G09G 3/36

(52) U.S. Cl. CPC G09G 3/3607; G09G 2300/0452
USPC 345/88

(57) ABSTRACT

The present invention causes an oblique line to be smoothly displayed on a liquid crystal display device in which pixels are each constituted by subpixels of four colors arranged in a matrix with two rows and two columns. When the oblique line is displayed, pixels include: a pixel which is not in contact with the oblique edge; and a pixel which is in contact with the oblique edge, supplied with the same data as is supplied to the pixel and different in luminance of a subpixel from the pixel, The pixel having a higher luminance than those of pixels adjacent to the subpixel of the pixel, and the subpixel of the pixel having a lower luminance than that of the subpixel of the pixel.

### TECHNICAL FIELD

The present invention relates to displaying of an edge on a liquid crystal display device in which one pixel is constituted by subpixels of four colors (e.g. red, green, blue, and white).

### BACKGROUND ART

There has been developed a liquid crystal display device in which one pixel is constituted by subpixels of four colors (red, green, blue, and white). One of the purposes of such a liquid crystal display device is to increase the luminance of a pixel.

### CITATION LIST

### Patent Literatures

Patent Literature 1
Japanese Patent Application Publication, Tokukai, No. 2007-286618 A (Publication Date: Nov. 1, 2007)

Patent Literature 2
Japanese Patent Application Publication, Tokukai, No. 2009-086054 A (Publication Date: Apr. 23, 2009)

### SUMMARY OF INVENTION

### Technical Problem

In a case where an object having an oblique edge (e.g., an oblique line) is displayed on a liquid crystal display device in which one pixel is constituted by subpixels of four colors arranged in a matrix with two rows and two columns, the oblique edge is not displayed smoothly. This is because, in a case where for example a line sloping down to the right is displayed, white subpixels each in the second row of the first column (see FIG. 13) become noticeable and therefore the oblique edge looks jagged.

An object of the present invention is to smoothly display an oblique edge on a liquid crystal display device in which one pixel is constituted by subpixels of four colors arranged in a matrix with two rows and two columns.

### Solution to Problem

A liquid crystal display device of the present invention is a liquid crystal display device in which each pixel is constituted by first-color to fourth-color subpixels arranged in a matrix with two rows and two columns, wherein: when an object having an oblique edge is displayed, (i) a first pixel on which the oblique edge does not fall and (ii) a second pixel (a) on which the oblique edge falls, (b) which is supplied with data identical to that supplied to the first pixel, and (c) in which the first-color subpixel has a different luminance from that of the first-color subpixel of the first pixel are in the liquid crystal display device; the second pixel has a higher luminance than those of pixels adjacent to the first-color subpixel of the second pixel; and the first-color subpixel of the second pixel has a lower luminance than that of the first-color subpixel of the first pixel. Note here that the “oblique edge” refers to, for example, an edge extending obliquely with respect to a direction in which a scanning signal line extends.

According to the configuration, it is possible, when an object having an oblique edge is displayed on a liquid crystal display device in which each pixel is constituted by subpixels of four colors arranged in a matrix with two rows and two columns, to make subpixels of a certain color (e.g. white) less noticeable at the oblique edge. This makes it possible to smoothly display an oblique edge (e.g. an oblique edge of a letter).

A liquid crystal display device of the present invention is a liquid crystal display device in which each pixel is constituted by first-color to fourth-color subpixels arranged in a matrix with two rows and two columns, wherein: when an object having an oblique edge is displayed, (i) a first pixel on which the oblique edge does not fall and (ii) a second pixel (a) on which the oblique edge falls, (b) which is supplied with data identical to that supplied to the first pixel, and (c) in which the first-color subpixel has a different luminance from that of the first-color subpixel of the first pixel are in the liquid crystal display device; the second pixel has a lower luminance than those of pixels adjacent to the first-color subpixel of the second pixel; and the first-color subpixel of the second pixel has a higher luminance than that of the first-color subpixel of the first pixel.

According to the configuration, it is possible, when an object having an oblique edge is displayed on a liquid crystal display device in which each pixel is constituted by subpixels of four colors arranged in a matrix with two rows and two columns, to make subpixels of a certain color (e.g. white) less noticeable at the oblique edge. This makes it possible to smoothly display an object having an oblique edge.

### Advantageous Effects of Invention

As has been described, the present invention makes it possible to smoothly display an oblique edge on a liquid crystal display device in which one pixel is constituted by subpixels of four colors arranged in a matrix with two rows and two columns.

### BRIEF DESCRIPTION OF DRAWINGS

FIG. 1 is a view schematically illustrating part of an oblique line (−45 degrees) displayed on a liquid crystal display device of the present embodiment (with edge processing).

FIG. 2 is a view schematically illustrating part of an oblique line (−45 degrees) displayed by a conventional technique (without edge processing).

FIG. 3 is a view schematically illustrating another part of the oblique line (−45 degrees) displayed on the liquid crystal display device of the present embodiment (with edge processing).

FIG. 4 is a view schematically illustrating another part of the oblique line (−45 degrees) displayed by a conventional technique (without edge processing).

FIG. 5 is a view schematically illustrating a method for generating standard RGBW data from RGB data.

FIG. 6 is a view schematically illustrating a method for generating output RGBW data by subjecting standard RGBW data to edge correction (correction of W subpixels).

FIG. 7 is a view schematically illustrating a method for generating output RGBW data by subjecting standard RGBW data to edge correction (correction of G subpixels).

FIG. 8 is a view schematically illustrating part of a steeply oblique line (−45 degrees to −90 degrees) displayed on the liquid crystal display device of the present embodiment (with edge processing).

FIG. 9 is a view schematically illustrating part of a steeply oblique line (−45 degrees to −90 degrees) displayed by a conventional technique (without edge processing).

FIG. 10 is a view schematically illustrating part of a slightly oblique line (−45 degrees to −0 degrees) displayed on the liquid crystal display device of the present embodiment (with edge processing).

FIG. 11 is a view schematically illustrating part of a slightly oblique line (−45 degrees to −0 degrees) displayed by a conventional technique (without edge processing).

FIG. 12 is a block diagram illustrating a configuration of a liquid crystal display device of the preset embodiment.

FIG. 13 is a view schematically illustrating a problem arising when an oblique line is displayed on a four-color liquid crystal display device.

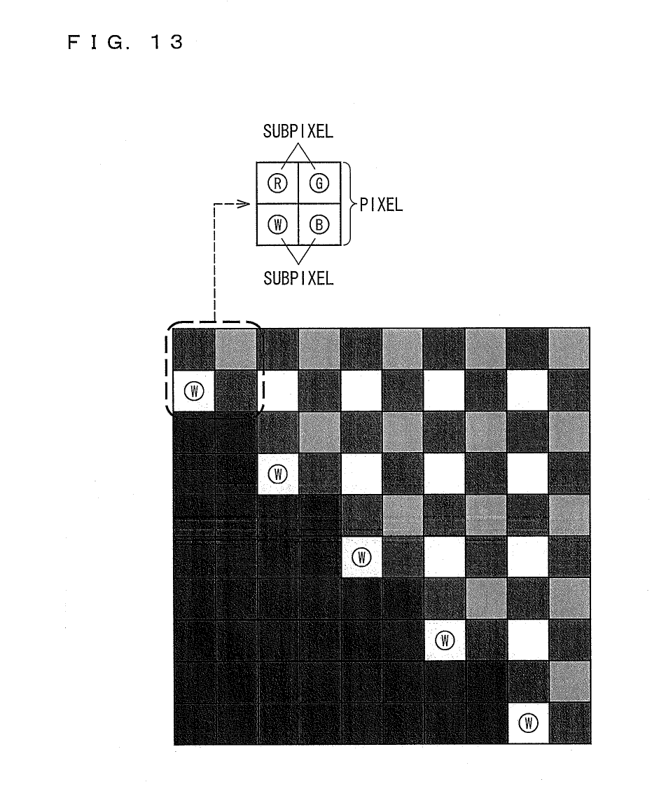

### DESCRIPTION OF EMBODIMENTS

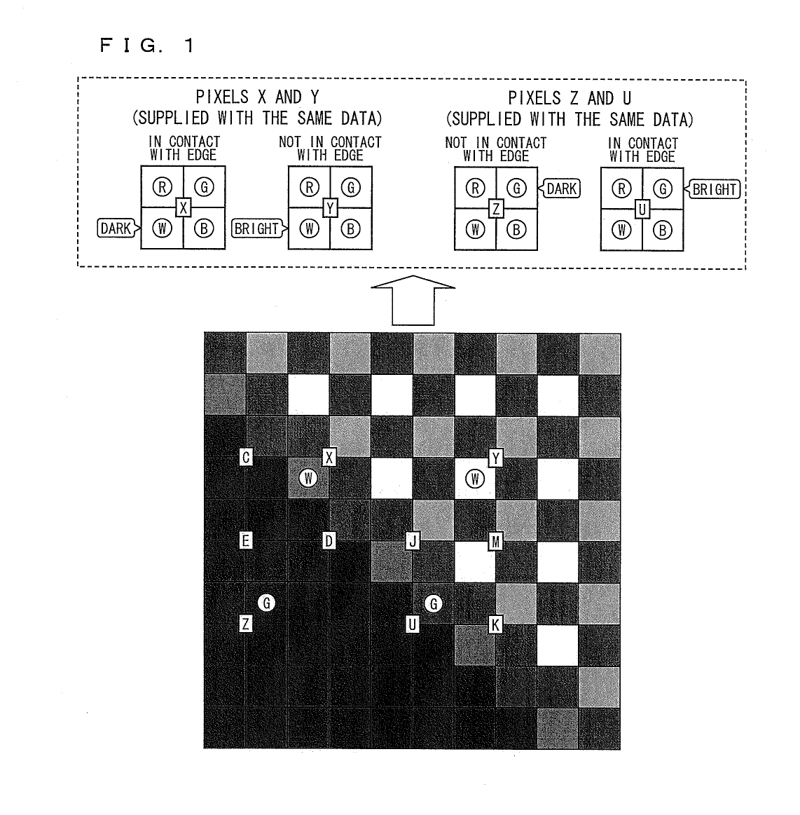

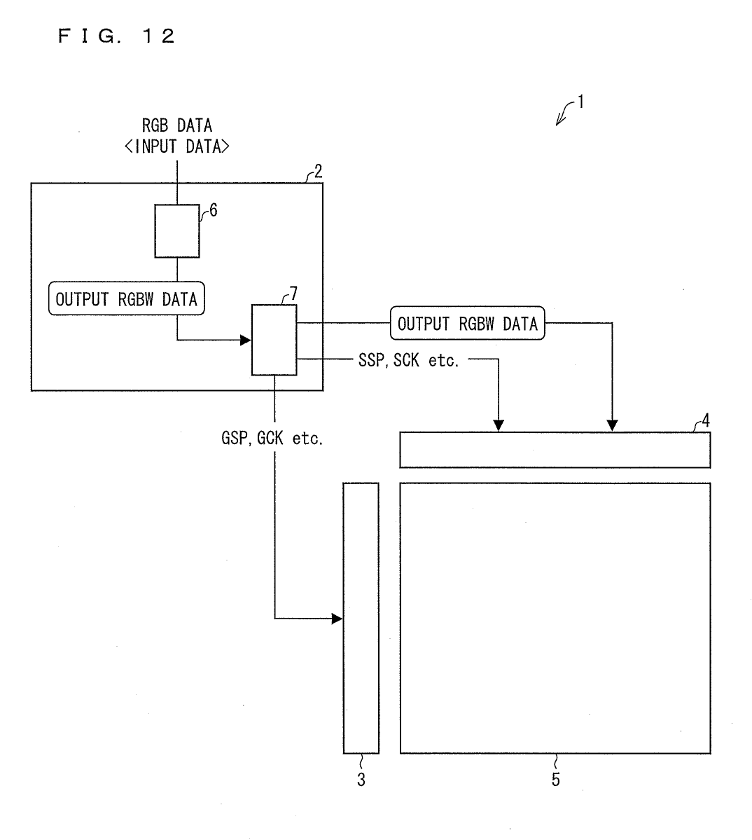

The following description will discuss an embodiment of the present invention with reference to FIGS. 1 through 12. As illustrated in FIG. 12, a liquid crystal display device 1 of the present embodiment includes a display control circuit 2, a gate driver 3, a source driver 4, and a liquid crystal panel 5. The gate driver 3 and the source driver 4 can be formed monolithically on the liquid crystal panel 5. The liquid crystal panel 5 is configured such that (i) each pixel is constituted by subpixels of four colors (R, G, B and W) and (ii) the subpixels of four colors in each pixel are arranged in a matrix with two rows and two columns. In the following description, the subpixels of R, G, B and W may be referred to as RSP, GSP, BSP, and WSP, respectively, for short.

The display control circuit 2 includes a data conversion circuit 6 and a timing control circuit 7. The data conversion circuit 6 (i) generates standard RGBW data from RGB data (input data), (ii) subjects the standard RGBW data to edge processing to obtain output RGBW data (described later in detail), and then (iii) supplies the output RGBW data to the timing control circuit 7. The timing control circuit 7 (a) supplies the output RGBW data, a source start pulse SSP, a source clock SCK, and the like to the source driver 4 and (b) supplies a gate start pulse GSP, a gate clock GCK, and the like to the gate driver 3.

The source driver 4 drives a source line (data signal line, not illustrated) of the liquid crystal panel 5 with use of the output RGBW data and the source start pulse SSP and the source clock SCK etc. The gate driver 3 drives a gate line (scanning signal line, not illustrated) of the liquid crystal panel 5 with use of the gate start pulse GSP and the gate clock GCK etc.

FIG. 1 illustrates part of an oblique line (line inclined at −45 degrees) displayed on the liquid crystal display device 1. Note that, in FIG. 1, an “edge of the oblique line (oblique edge)” refers to a boundary (step-like shape) between (i) a low-luminance region (made up of a plurality of subpixels) in a bottom-left part and (ii) a high-luminance region (made up of a plurality of subpixels) in a top-right part. Further note that, in FIG. 1, “a pixel in contact with the oblique edge” refers to a pixel through which the oblique edge passes or which is adjacent to the oblique edge.

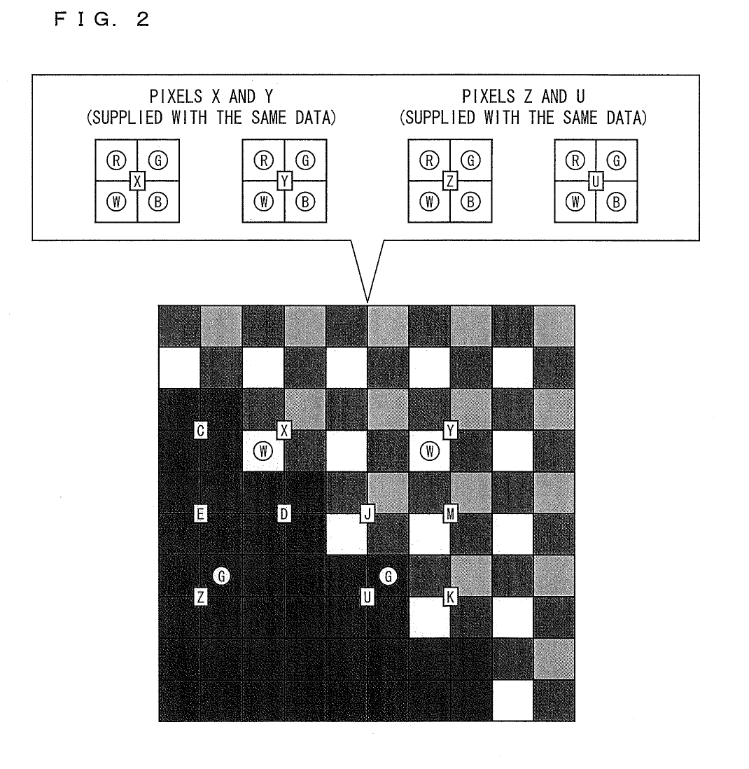

In order to carry out edge processing, according to the liquid crystal display device 1, when the oblique line is displayed, pixels include (i) a pixel Y (first pixel) which is not in contact with the oblique edge, (ii) a pixel X (second pixel) which is in contact with the oblique edge, is supplied with the same data as is supplied to the pixel Y, and is different in luminance of a white subpixel (W, first color) from the pixel Y, (iii) a pixel Z (third pixel) which is not in contact with the oblique edge, and (iv) a pixel U (fourth pixel) which is in contact with the oblique edge, is supplied with the same data as is supplied to the pixel Z, and is different in luminance of a green subpixel (G, second color) from the pixel Z. The pixel X has a luminance higher than those of pixels C and D which are adjacent to the W subpixel of the pixel X, and the W subpixel of the pixel X has a luminance lower than that of the W subpixel of the pixel Y. The pixel U has a luminance lower than those of pixels J and K which are adjacent to the G subpixel of the pixel U, and the G subpixel of the pixel U has a luminance higher than that of the G subpixel of the pixel Z. Since the oblique line is displayed like above, the edge is displayed more smoothly than a conventional technique as illustrated in FIG. 2 (a case where the oblique line is displayed without edge processing).

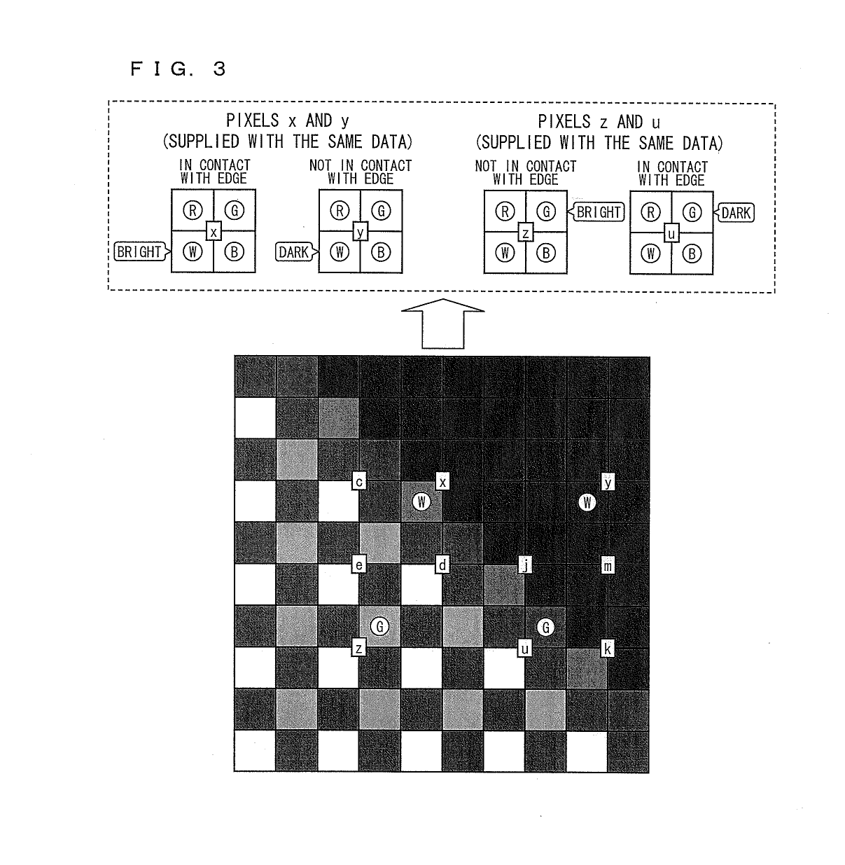

FIG. 3 illustrates another part of the oblique line (line inclined at −45 degrees) displayed on the liquid crystal display device 1. An “edge of the oblique line (oblique edge)” in FIG. 3 refers to a boundary (step-like shape) between (i) a low-luminance region (made up of a plurality of subpixels) in a top-right part and (ii) a high-luminance region (made up of a plurality of subpixels) in a bottom-left part. A “pixel in contact with the oblique edge” in FIG. 3 refers to a pixel through which the oblique edge passes or which is adjacent to the oblique edge.

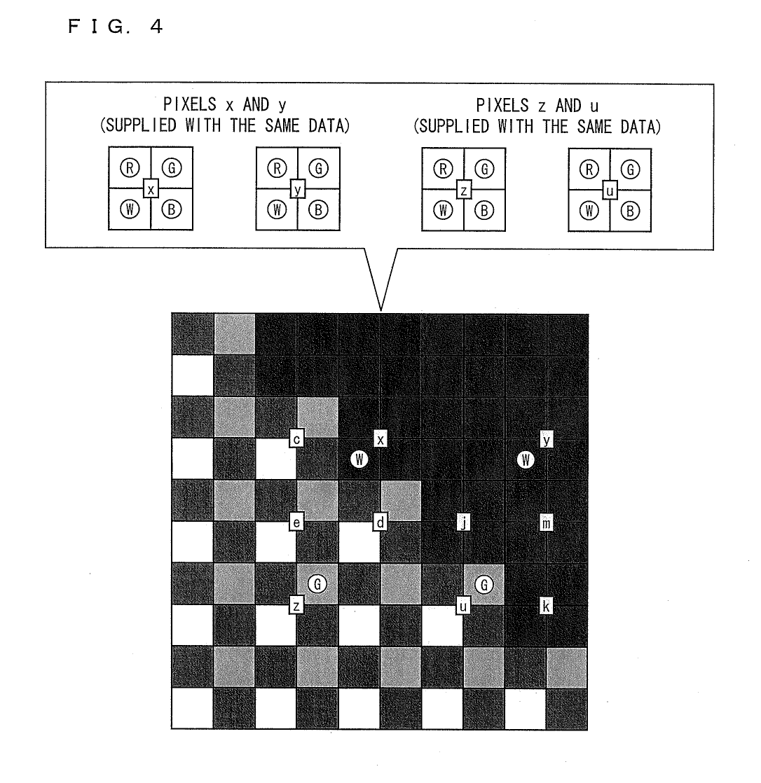

In order to carry out edge processing, according to the liquid crystal display device 1, when the oblique line is displayed, pixels include (i) a pixel y (first pixel) which is not in contact with the oblique edge, (ii) a pixel x (second pixel) which is in contact with the oblique edge, is supplied with the same data as is supplied to the pixel y, and is different in luminance of a white subpixel (W, first color) from the pixel y, (iii) a pixel z (third pixel) which is not in contact with the oblique edge, and (iv) a pixel u (fourth pixel) which is in contact with the oblique edge, is supplied with the same data as is supplied to the pixel z, and is different in luminance of a green subpixel (G, second color) has a luminance different the pixel z. The pixel x has a luminance lower than those of pixels c and d which are adjacent to the W subpixel of the pixel x, and the W subpixel of the pixel x has a luminance higher than that of the W subpixel of the pixel y. The pixel u has a luminance higher than those of pixels j and k which are adjacent to the G pixel of the pixel u, and the G subpixel of the pixel u has a luminance lower than that of the G subpixel of the pixel z. Since the oblique line is displayed like above, the edge is displayed more smoothly than a conventional technique as illustrated in FIG. 4 (a case where the oblique line is displayed without edge processing).

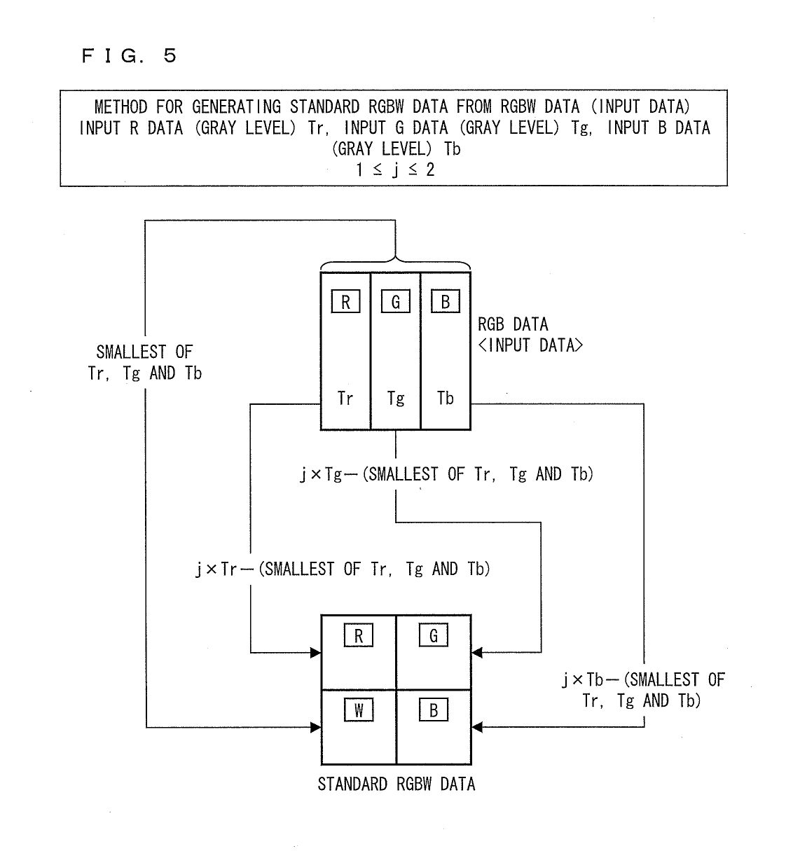

The following description will discuss a method for generating output RGBW data from RGB data (input data). First, the RGB data (input data) is converted into standard RGBW data (see FIG. 5). Specifically, in a case where RGB data specifies RSP=gray level Tr, GSP=gray level Tg and BSP=gray level Tb, obtained standard RGBW data specifies gray levels such that RSP=j×Tr−(the smallest of Tr, Tg and Tb), GSP=j×Tg−(the smallest of Tr, Tg and Tb), BSP=j×Tb−(the smallest of Tr, Tg and Tb), and WSP=the smallest of Tr, Tg and Tb (in these equations, 1≦j≦2).

For example, in a case where RGB data (8-bit, 256-gray-level data) specifies RSP=gray level 250, GSP=gray level 250 and BSP=gray level 250, obtained standard RGBW data specifies RSP=2×250−(250)=gray level 250, GSP=2×250−(250)=gray level 250, BSP=2×250−(250)=gray level 250, and WSP=gray level 250.

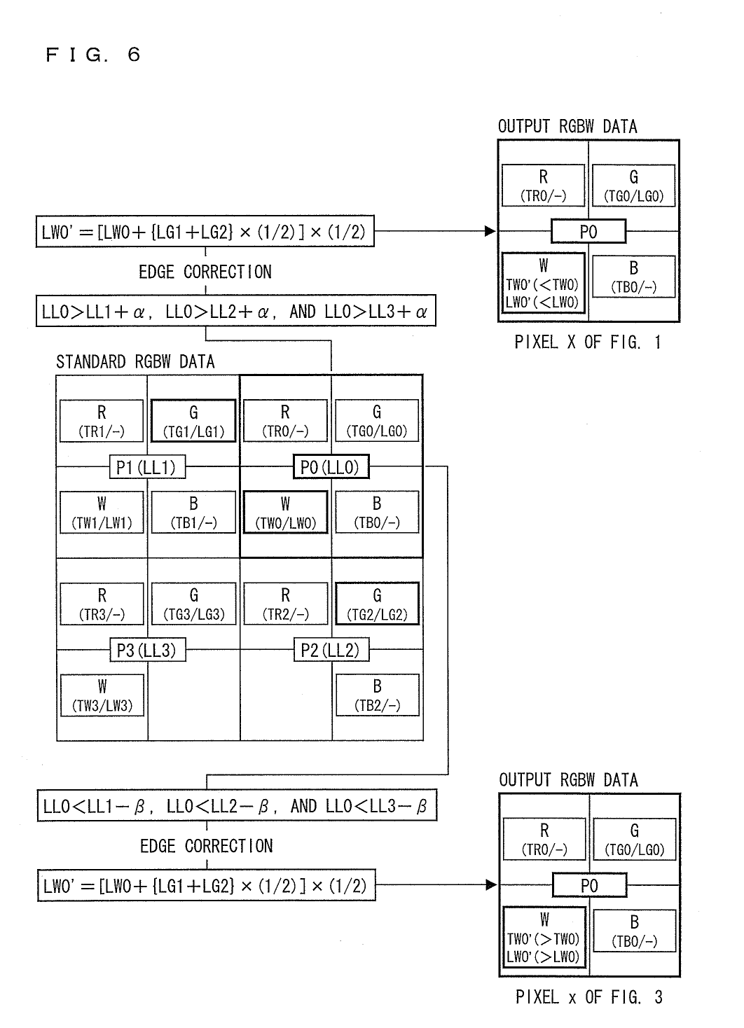

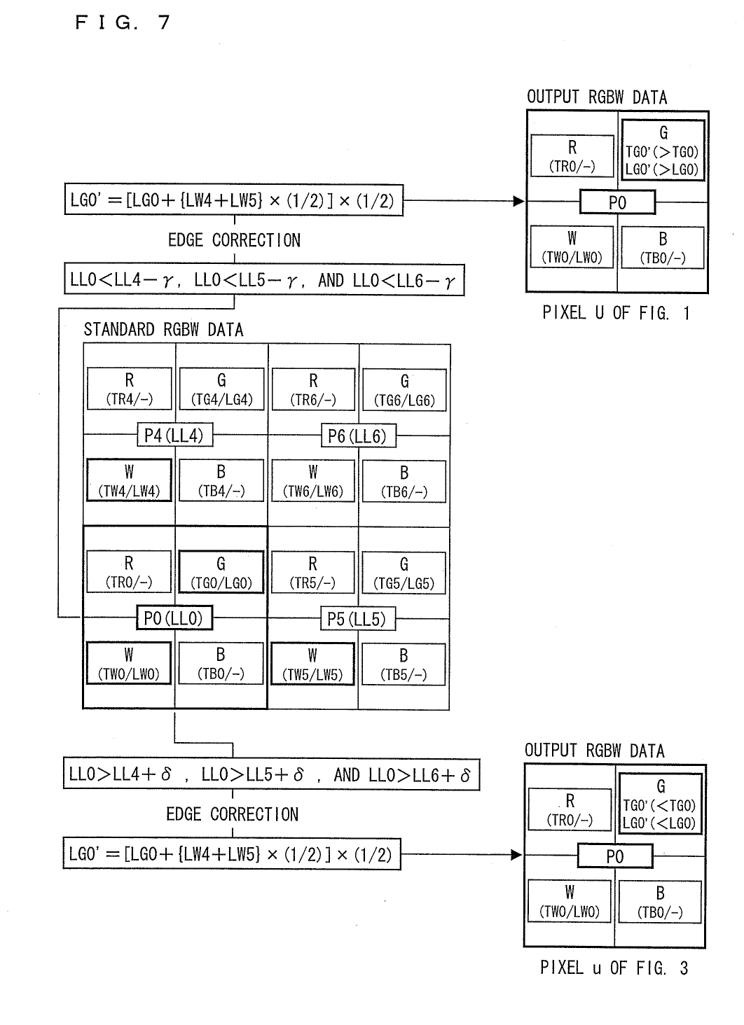

Next, the standard RGBW data is subjected to edge correction and thereby output RGBW data is generated (see FIGS. 6 and 7).

FIG. 6 is based on the following assumption. Standard RGBW data (gray levels) for a pixel P0 is such that RSP=TR0, GSP=TG0, BSP=TB0, and WSP=TW0. Standard luminance of the pixel P0 calculated from the standard RGBW data for the pixel P0 is LL0, standard luminance of the GSP of the pixel P0 calculated from TG0 is LG0, and standard luminance of the WSP of the pixel P0 calculated from TW0 is LW0. Further, standard RGBW data (gray levels) for a pixel P1, which is adjacent in a row direction to the WSP of the pixel P0, is such that RSP=TR1, GSP=TG1, BSP=TB1, and WSP=TW1. Standard luminance of the pixel P1 calculated from the standard RGBW data for the pixel P1 is LL1, standard luminance of the GSP of the pixel P1 calculated from TG1 is LG1, and standard luminance of the WSP of the pixel P1 calculated from TW1 is LW1. Furthermore, standard RGBW data (gray levels) for a pixel P2, which is adjacent in a column direction to the WSP of the pixel P0, is such that RSP=TR2, GSP=TG2, BSP=TB2, WSP=TW2. Standard luminance of the pixel P2 calculated from the standard RGBW data for the pixel P2 is LL2, standard luminance of the GSP of the pixel P2 calculated from TG2 is LG2, and standard luminance of the WSP of the pixel P2 calculated from TW2 is LW2. Moreover, standard RGBW data (gray levels) for a pixel P3, which is diagonally opposite the pixel P0, is such that RSP=TR3, GSP=TG3, BSP=TB3, and WSP=TW3. Standard luminance of the pixel P3 calculated from the standard RGBW data for the pixel P3 is LL3, standard luminance of the GSP of the pixel P3 calculated from TG3 is LG3, and standard luminance of the WSP of the pixel P3 calculated from TW3 is LW3.

In a case where LL0>LL1+α, LL0>LL2+α, and LL0>LL3+α are satisfied, it is determined that the pixel P0 is in contact with an oblique edge and requires edge correction.

Then, output RGBW data (gray levels) for the pixel P0 is prepared such that RSP=TR0, GSP=TG0, BSP=TB0, WSP=TW0′ (<TW0). Note that α is zero or a positive number. Assuming that corrected luminance (actual luminance) of the WSP of the pixel P0 calculated from TW0 is LW0′, then LW0′=[LW0+(LG1+LG2)×(½)]×(½)<LW0. In this case, (i) LW0′ corresponds to the luminance of the WSP of the pixel X illustrated in FIG. 1, (ii) LW0 corresponds to the luminance of the WSP of the pixel X illustrated in FIG. 2, (iii) LG1 corresponds to the luminance of the GSP of the pixel C illustrated in FIG. 2, and (iv) LG2 corresponds to the luminance of the GSP of the pixel D illustrated in FIG. 2.

On the other hand, also in a case where LL0<LL1−βLL0<LL2−β, and LL0<LL3−β are satisfied, it is determined that the pixel 0 is in contact with the oblique edge and requires edge correction. Then, output RGBW data (gray levels) for the pixel P0 is prepared such that RSP=TR0, GSP=TG0, BSP=TB0, and WSP=TW0′ (>TW0). Note that is zero or a positive number. Assuming that corrected luminance of the WSP of the pixel P0 calculated form TW0′ is LW0′, then LW0′=[LW0+(LG1+LG2)×(½)]×(½)>LW0. In this case, (i) LW0′ corresponds to the luminance of the WSP of the pixel x illustrated in FIG. 3, (ii) LW0 corresponds to the luminance of the WSP of the pixel x illustrated in FIG. 4, (iii) LG1 corresponds to the luminance of the GSP of the pixel c illustrated in FIG. 4, and (iv) LG2 corresponds to the luminance of the GSP of the pixel d illustrated in FIG. 4.

FIG. 7 is based on the following assumption. Standard RGBW data (gray levels) for a pixel P0 is such that RSP=TR0, GSP=TG0, BSP=TB0, and WSP=TW0. Standard luminance of the pixel P0 calculated from the standard RGBW data for the pixel P0 is LL0, standard luminance of the GSP of the pixel P0 calculated from TG0 is LG0, and standard luminance of the WSP of the pixel P0 calculated from TW0 is LW0. Further, standard RGBW data (gray levels) for a pixel P4, which is adjacent in a column direction to the GSP of the pixel P0, is such that RSP=TR4, GSP=TG4, BSP=TB4, and WSP=TW4. Standard luminance of the pixel P4 calculated from the standard RGBW data for the pixel P4 is LL4, standard luminance of the GSP of the pixel P4 calculated from TG4 is LG4, and standard luminance of the WSP of the pixel P4 calculated from TW4 is LW4. Furthermore, standard RGBW data (gray levels) for a pixel P5, which is adjacent in a row direction to the GSP of the pixel P0, is such that RSP=TR5, GSP=TG5, BSP=TB5, and WSP=TW5. Standard luminance of the pixel P5 calculated from the standard RGBW data for the pixel P5 is LL5, standard luminance of the GSP of the pixel P5 calculated from TG5 is LG5, and standard luminance of the WSP of the pixel P5 calculated from TW5 is LW5. Moreover, standard RGBW data (gray levels) for a pixel P6, which is diagonally opposite the pixel P0, is such that RSP=TR6, GSP=TG6, BSP=TB6, and WSP=TW6. Standard luminance of the pixel P6 calculated from the standard RGBW data for the pixel P6 is LL6, standard luminance of the GSP of the pixel P6 calculated from TG6 is LG6, and standard luminance of the WSP of the pixel P6 calculated from TW6 is LW6.

In a case where LL0<LL4−γ, LL0<LL5−γ, and LL0<LL6−γ are satisfied, it is determined that the pixel P0 is in contact with an oblique edge and requires edge correction. Then, output RGBW data (gray levels) for the pixel P0 is prepared such that RSP=TR0, GSP=TG0′ (>TG0), BSP=TB0, and WSP=TW0. Note that γ is zero or a positive number. Assuming that corrected luminance of the GSP of the pixel P0 calculated from TG0′ is LG0′, then LG0′=[LG0+(LW4+LW5)×(½)]×(½)>LG0. In this case, (i) LG0′ corresponds to the luminance of the GSP of the pixel U illustrated in FIG. 1, (ii) LG0 corresponds to the luminance of the GSP of the pixel U illustrated in FIG. 2, (iii) LW4 corresponds to the luminance of the GSP of the pixel J illustrated in FIG. 2, and (iv) LW5 corresponds to the luminance of the WSP of the pixel K illustrated in FIG. 2.

On the other hand, in a case where LL0>LL4+δ, LL0>LL5+δ, and LL0>LL6+δ are satisfied, it is determined that the pixel P0 is in contact with the oblique edge and requires edge correction. Then, output RGBW data (gray levels) for the pixel P0 is prepared such that RSP=TR0, GSP=TG0′ (<TG0), BSP=TB0, and WSP=TW0. Note that δ is zero or a positive number. Assuming that corrected luminance (actual luminance) of the WSP of the pixel P0 calculated from TG0′ is LG0′, then LG0′=[LG0+(LW4+LW5)×(½)]×(½)<LG0. In this case, (i) LG0′ corresponds to the luminance of the GSP of the pixel u illustrated in FIG. 3, (ii) LG0 corresponds to the luminance of the GSP of the pixel u illustrated in FIG. 4, (iii) LW4 corresponds to the luminance of the WSP of the pixel j illustrated in FIG. 4, and (iv) LW5 corresponds to the luminance of the WSP of the pixel k illustrated in FIG. 4.

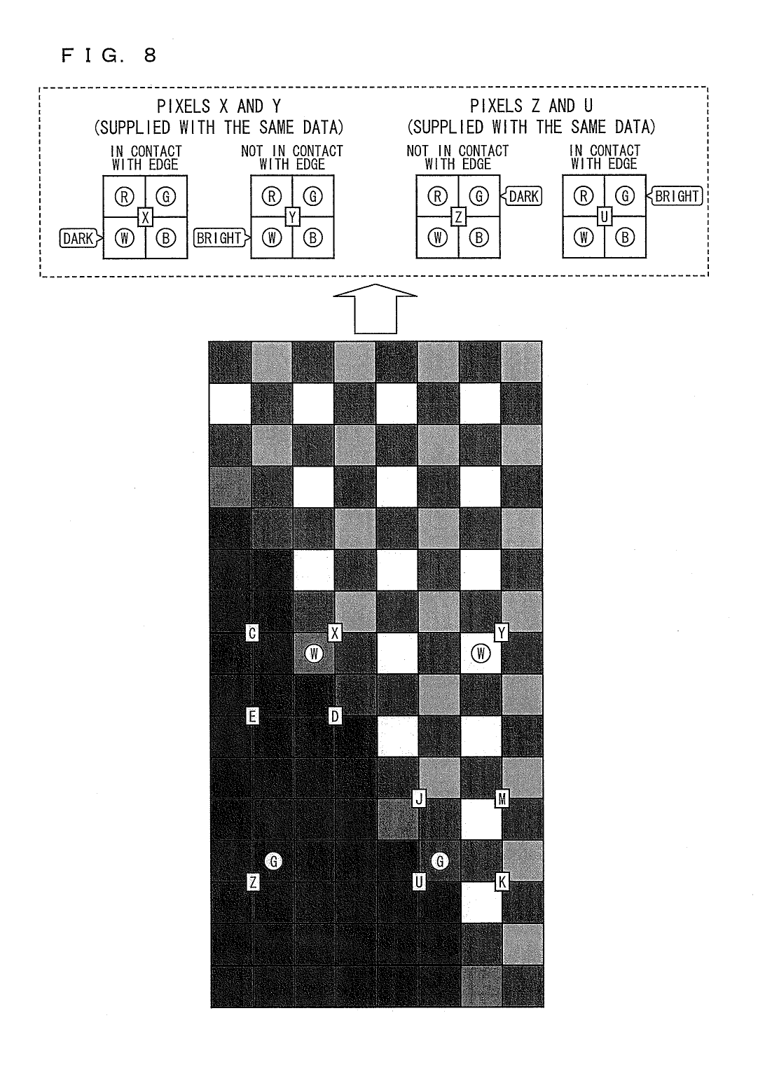

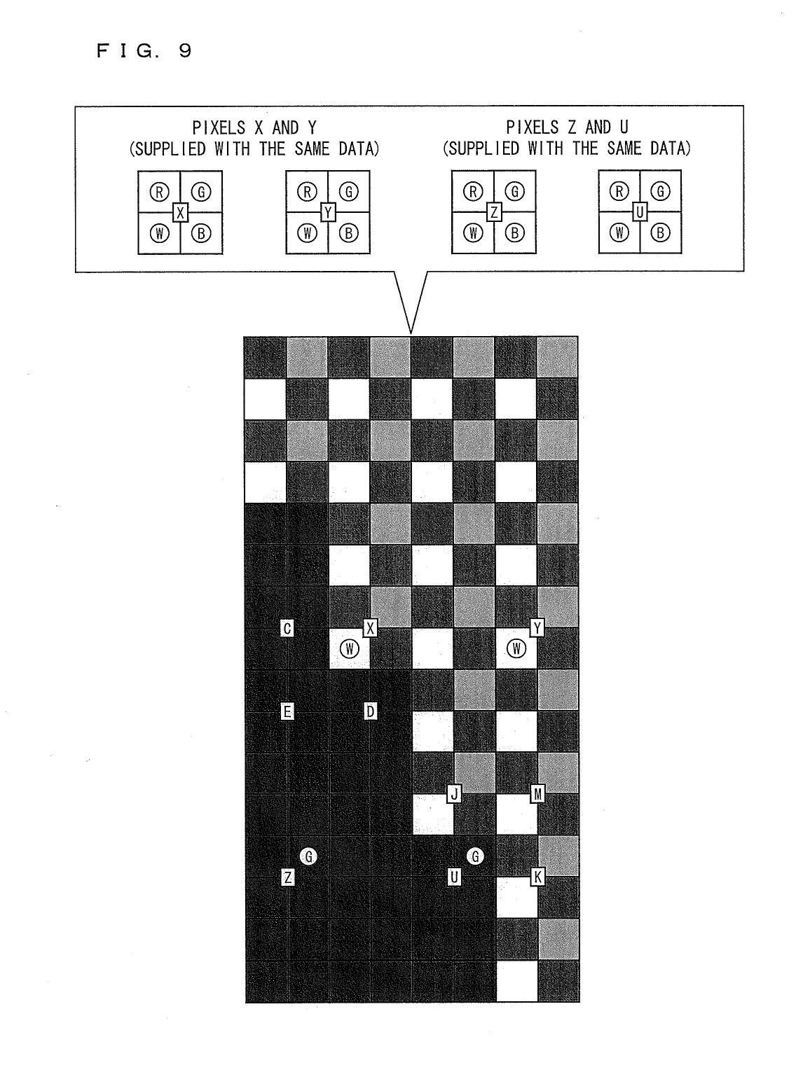

FIG. 8 illustrates part of a steeply oblique line (line inclined at −45 degrees to −90 degrees) displayed on the liquid crystal display device 1. In order to carry out edge processing, according to the liquid crystal display device 1, when the oblique line is displayed, pixels include (i) a pixel Y (first pixel) which is not in contact with the oblique edge, (ii) a pixel X (second pixel) which is in contact with the oblique edge, is supplied with the same data as is supplied to the pixel Y, and is different in luminance of a white subpixel (W, first color) from the pixel Y, (iii) a pixel Z (third pixel) which is not in contact with the oblique edge, and (iv) a pixel U (fourth pixel) which is in contact with the oblique edge, is supplied with the same data as is supplied to the pixels Z, and is different in luminance of a green subpixel (G, second color) from the pixel Z. The pixel X has a luminance higher than those of pixels C and D which are adjacent to the W subpixel of the pixel X, and the W subpixel of the pixel X has a luminance lower than that of the W subpixel of the pixel Y. The pixel U has a luminance lower than those of pixels J and K which are adjacent to the G pixel of the pixel U, and the G subpixel of the pixel U has a luminance higher than that of the G subpixel of the pixel Z. Since the oblique line is displayed like above, the edge is displayed more smoothly than a conventional technique as illustrated in FIG. 9 (a case where the oblique line is displayed without edge processing).

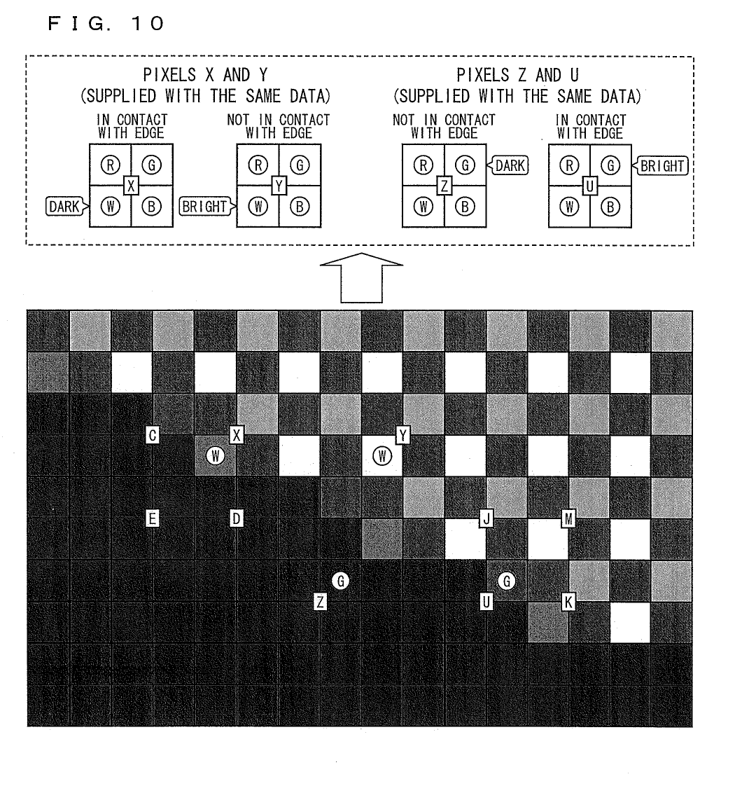

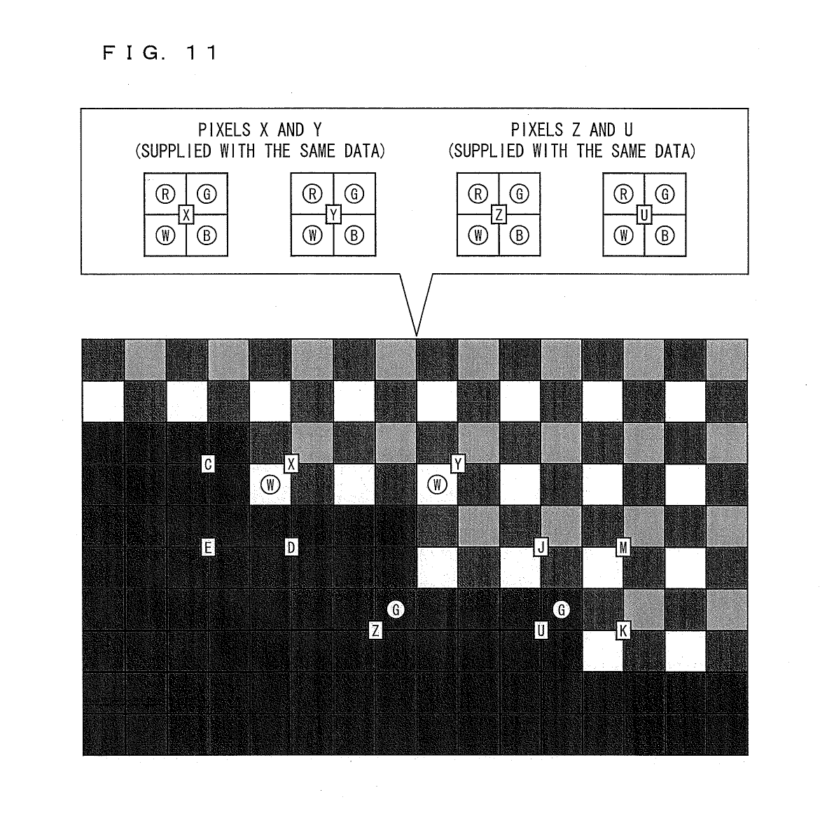

FIG. 10 illustrates part of a slightly oblique line (line inclined at −45 degrees to 0 degrees) displayed on the liquid crystal display device 1. In order to carry out edge processing, according to the liquid crystal display device 1, when the oblique line is displayed, pixels include (i) a pixel Y (first pixel) which is not in contact with the oblique edge, (ii) a pixel X (second pixel) which is in contact with the oblique edge, is supplied with the same data as is supplied to the pixel Y, and is different in luminance of a white subpixel (W, first color) from the pixel Y, (iii) a pixel Z (third pixel) which is not in contact with the oblique edge, and (iv) a pixel U (fourth pixel) which is in contact with the oblique edge, is supplied with the same data as is supplied to the pixel Z, and is different in luminance of a green subpixel (G, second color) from the pixel Z. The pixel X has a luminance higher than those of pixels C and D which are adjacent to the W subpixel of the pixel X, and the W subpixel of the pixel X has a luminance lower than that of the W subpixel of the pixel Y. The pixel U has a luminance lower than those of pixels J and K which are adjacent to the G subpixel of the pixel U, and the G subpixel of the pixel U has a luminance higher than that of the G subpixel of the pixel Z. Since the oblique line is displayed like above, the edge is displayed more smoothly than a conventional technique as illustrated in FIG. 11 (a case where the oblique line is displayed without edge processing).

The liquid crystal display device of the present invention can be configured such that: when an object having an oblique edge is displayed, (i) a third pixel on which the oblique edge does not fall and (ii) a fourth pixel (a) on which the oblique edge falls, (b) which is supplied with data identical to that supplied to the third pixel, and (c) in which the second-color subpixel has a different luminance from that of the second-color subpixel of the third pixel are in the liquid crystal display device; the fourth pixel has a lower luminance than those of pixels adjacent to the second-color subpixel of the fourth pixel; and the second-color subpixel of the fourth pixel has a higher luminance than that of the second-color subpixel of the third pixel. The liquid crystal display device of the present invention can be configured such that: when an object having an oblique edge is displayed, (i) a third pixel on which the oblique edge does not fall and (ii) a fourth pixel (a) on which the oblique edge falls, (b) which is supplied with data identical to that supplied to the third pixel, and (c) in which the second-color subpixel has a different luminance from that of the second-color subpixel of the third pixel are in the liquid crystal display device; the fourth pixel has a higher luminance than those of pixels adjacent to the second-color subpixel of the fourth pixel; and the second-color subpixel of the fourth pixel has a lower luminance than that of the second-color subpixel of the third pixel.

The liquid crystal display device of the present invention can be configured such that, when same gray levels are displayed in the first-color to fourth-color subpixels, such that: luminance of the first-color subpixel is higher than luminance of the second-color subpixel; the luminance of the second-color subpixel is higher than luminance of the third-color subpixel; and the luminance of the third-color subpixel is higher than luminance of the fourth-color subpixel.

The liquid crystal display device of the present invention can be configured such that, in one pixel, the first-color subpixel and the second-color subpixel are diagonally opposite each other.

The liquid crystal display device can be configured such that the first color is white and the second color is green. In this case, the liquid crystal display device can also be configured such that the third color is red and the fourth color is blue.

The present invention is not limited to the embodiments above, but a modification of any one of the embodiments based on technical common sense or a combination of such modification is encompassed in the embodiments of the present invention.

### INDUSTRIAL APPLICABILITY

A liquid crystal display device of the present invention is suitable for, for example, electronic books, mobile phones, and laptop computers, and the like.

### REFERENCE SIGNS LIST

X, x First pixel
Y Second pixel
U, u First pixel
Z, z Second pixel
R Red
G Green
B Blue
W White
1 Liquid crystal display device
2 Display control circuit
5 Liquid crystal panel
6 Data conversion circuit

1. A liquid crystal display device in which each pixel is constituted by first-color to fourth-color subpixels arranged in a matrix with two rows and two columns, wherein:
when an object having an oblique edge is displayed, (i) a first pixel on which the oblique edge does not fall and (ii) a second pixel (a) on which the oblique edge falls, (b) which is supplied with data identical to that supplied to the first pixel, and (c) in which the first-color subpixel has a different luminance from that of the first-color subpixel of the first pixel are in the liquid crystal display device;
the second pixel has a higher luminance than those of pixels adjacent to the first-color subpixel of the second pixel; and
the first-color subpixel of the second pixel has a lower luminance than that of the first-color subpixel of the first pixel.

2. The liquid crystal display device as set forth in claim 1, wherein:
when an object having an oblique edge is displayed, (i) a third pixel on which the oblique edge does not fall and (ii) a fourth pixel (a) on which the oblique edge falls, (b) which is supplied with data identical to that supplied to the third pixel, and (c) in which the second-color subpixel has a different luminance from that of the second-color subpixel of the third pixel are in the liquid crystal display device;
the fourth pixel has a lower luminance than those of pixels adjacent to the second-color subpixel of the fourth pixel; and
the second-color subpixel of the fourth pixel has a higher luminance than that of the second-color subpixel of the third pixel.

3. A liquid crystal display device in which each pixel is constituted by first-color to fourth-color subpixels arranged in a matrix with two rows and two columns, wherein:
when an object having an oblique edge is displayed, (i) a first pixel on which the oblique edge does not fall and (ii) a second pixel (a) on which the oblique edge falls, (b) which is supplied with data identical to that supplied to the first pixel, and (c) in which the first-color subpixel has a different luminance from that of the first-color subpixel of the first pixel are in the liquid crystal display device;
the second pixel has a lower luminance than those of pixels adjacent to the first-color subpixel of the second pixel; and
the first-color subpixel of the second pixel has a higher luminance than that of the first-color subpixel of the first pixel.

4. The liquid crystal display device as set forth in claim 3, wherein:
when an object having an oblique edge is displayed, (i) a third pixel on which the oblique edge does not fall and (ii) a fourth pixel (a) on which the oblique edge falls, (b) which is supplied with data identical to that supplied to the third pixel, and (c) in which the second-color subpixel has a different luminance from that of the second-color subpixel of the third pixel are in the liquid crystal display device;
the fourth pixel has a higher luminance than those of pixels adjacent to the second-color subpixel of the fourth pixel; and
the second-color subpixel of the fourth pixel has a lower luminance than that of the second-color subpixel of the third pixel.

5. The liquid crystal display device as set forth in claim 1, wherein, when same gray levels are displayed in the first-color to fourth-color subpixels:
luminance of the first-color subpixel is higher than luminance of the second-color subpixel;
the luminance of the second-color subpixel is higher than luminance of the third-color subpixel; and
the luminance of the third-color subpixel is higher than luminance of the fourth-color subpixel.

6. The liquid crystal display device as set forth in claim 5, wherein, in one pixel, the first-color subpixel and the second-color subpixel are diagonally opposite each other.

7. The liquid crystal display device as set forth in claim 5, wherein the first color is white and the second color is green.

8. The liquid crystal display device as set forth in claim 7, wherein the third color is red and the fourth color is blue.
